(19) United States
(12) Patent Application Publication
(10) Pub. No.: US 2023/0048357 A1
(43) Pub. Date: Feb. 16, 2023

(54) COMMUNICATING SYSTEM COMPRISING A REMOVABLE DEVICE AND A DOCKING DEVICE

(71) Applicant: THALES, Courbevoie (FR)

(72) Inventor: Dorian SANTIAGO, Merignac (FR)

(21) Appl. No.: 17/788,139

(22) PCT Filed: Dec. 21, 2020
(86) PCT No.: PCT/EP2020/087499

§ 371 Date: Jun. 22, 2022

(30) Foreign Application Priority Data
Dec. 23, 2019 (FR) FR1915403

(51) Int. Cl. G06F 13/40; G06F 3/14

(52) U.S. Cl. CPC G06F 13/4081; G06F 3/14; H04N 21/41422

(57) ABSTRACT

The present invention relates to a communication system comprising a removable device comprising a display screen, and a docking device apt to receive the removable device.

Each of the removable device and the docking device comprises an extreme high frequency communication chip, the communication chips being positioned opposite each other when the removable device is received in the docking device and are apt to exchange digital data between each other.

The display screen is apt to display images from the digital data sent by the communication chip of the docking device to the communication chip of the removable device.

### CROSS-REFERENCE TO RELATED APPLICATIONS

The present Application for Patent is a National Stage Entry of International Application No. PCT/EP2020/087499, filed Dec. 21, 2020, which claims priority to French Patent Application No. 19 15403, filed Dec. 23, 2019. The disclosure of the priority documents are incorporated in their entirety by reference therein.

### BACKGROUND OF THE INVENTION

The present invention relates to a communication system comprising a removable device and a docking device.

The removable device of the system according to the invention in particular, comprises a display screen which can be used as a passenger entertainment terminal in a means of transport such as an aircraft.

In a way that is known per se, such entertainment terminals are often built-into the passenger seats, allowing passengers sitting behind said seats to use the terminals.

Each terminal is generally connected to the computer network as well as to the aircraft power network via suitable connectors which are also built-into the corresponding seat.

However, managing and maintaining such entertainment terminals can be tedious.

Indeed, in the event of a breakdown, an update or a replacement of such a terminal, it is necessary to immobilize the aircraft and to carry out the disassembly of all or part of the seat in order to be able to access the attachment system of the corresponding terminal.

Once accessible, the terminal has to be disconnected from the power supply and data system thereof via dedicated connectors. Disconnecting these connectors, often performed blindly, is often a cause of additional deterioration of the display connectors, or worse, of the connectors coming from the sources. This can then entail repairs to the source cables and a long and costly aircraft downtime.

Moreover, it is clear that, given the operating environment of the entertainment terminals, the connectors used for said terminals, have to be sufficiently reliable to avoid accidental disconnection thereof due e. g. to vibrations the aircraft is subject to.

Connectors traditionally used in the state-of-the-art for entertainment terminals have “lever” locking systems which provide a good contact and holding of terminals.

And yet the “lever” locking systems require a significant clearance zone and do not provide a significant integration of the corresponding terminal into the seat.

E.g. a connector cannot be perpendicular to the terminal, because the source-side counterpart thereof, could not be built-into the thickness of the seat.

Finally, despite the “lever” locking thereof, the connector contacts wear quickly and may accumulate exterior elements in a cab environment open to the public (dust, moisture, etc.) thereby reducing the service life thereof or adding design complexity in order to protect same from the exterior environment.

In summary, the existing connectors of entertainment terminals cannot be easily disconnected, are not sufficiently reliable and resistant to exterior conditions, and are relatively bulky.

At least one of these problems may be encountered in any other communication system that comprises a display screen that must be connected to a source in a limited space and possibly in an environment that is subject to vibrations.

### SUMMARY OF THE INVENTION

The subject matter of the present invention is to provide a communication system for reliably connecting a display screen while remaining compact and allowing the display to be easily connected/disconnected.

For this purpose, the subject matter of the present invention is a communication system comprising a removable device comprising a display screen; and a docking device apt to receive the removable device.

The system comprises:
each of the removable device and the docking device comprises an Extreme High Frequency communication chip, the communication chips being positioned one opposite the other without any contact when the removable device is received in the docking device, and are apt to exchange digital data in this position, in the form of radio signals;
the display screen is apt to display images from the digital data sent by the communication chip of the docking device to the communication chip of the removable device.

According to other advantageous aspects of the invention, the system comprises one or more of the following characteristics, taken individually or according to all technically possible combinations:
the docking device further comprises a communication module connected to a computer network either via a wired link or a wireless link, the communication chip of the docking device being apt to exchange digital data with said computer network via the communication module;
the communication chips are apt to exchange digital data between each other through an Ethernet-type protocol;
the docking device further comprises an induction charger connected to a power supply;
the removable device further comprises an induction charging receiver positioned opposite the induction charger when the removable device is received in the docking device and apt to generate an electrical current in this position by interaction with the induction charger, to power the components of the removable device;
the removable device has a housing that defines a rear wall, side walls and a front wall;
the front wall receives the display screen;
the rear wall and the side walls define a smooth surface without any connecting element;
the docking device comprises a background wall and the removable device comprises a rear wall intended to be opposite the bottom wall when the removable device is received in the docking device;
the system further comprises holding means which are apt to hold the rear wall away from the bottom wall by a predetermined distance when the removable device is received in the docking device;
the holding means comprise a conductive shim arranged between the bottom wall and the rear wall;
the system as previously described is intended to be placed in an environment subject to vibrations;
the system as previously described has a passenger entertainment terminal of a mobile means of transport;
the docking device is built-into a seat in front of the passenger seat for which the entertainment terminal is intended; and
tilting devices apt for holding the docking device in the corresponding seat at an adjustable tilt angle.

### BRIEF DESCRIPTION OF THE DRAWINGS

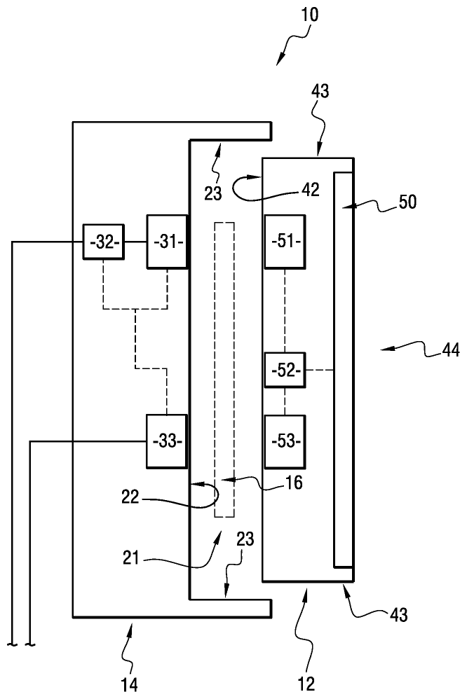

The characteristics and advantages of the invention will appear upon reading the following description, given only as a non-limiting example, and making reference to only one figure [FIG. 1] which shows a schematic communication system according to the invention.

### DETAILED DESCRIPTION OF PREFERRED EMBODIMENTS

In the enclosed figure, the communication system according to the invention is referred to by the general reference 10.

The communication system 10 allows a user to receive digital data and/or analog signals.

In the first case, the digital data comes from a remote computer or server and are sent e. g. via a computer network. In that case, advantageously according to the invention, the communication system 10 further allows the user to send digital data to said computer or said server.

In the second case, the analog signals come from an analog source, e.g. a source of audio and/or video signals.

The communication system 10 can be used in particular in an environment subject to vibrations.

In the example described below, the communication system 10 can be used in a passenger transport means such as an aircraft.

In particular, in this example, the communication system 10 is part of an in-flight entertainment system known as the English term “in-flight entertainment” or “IFE”.

In particular, in this example, the communication system 10 has an entertainment terminal associated with a passenger.

Of course, other examples of the embodiment of the invention are further possible.

With reference to the enclosed figure, the communication system 10 comprises a removable device 12, a docking device 14 apt to receive the removable device 12 and means of holding 16 said removable device 12 in the docking device 14.

As shown in the figure, the docking device 14 is in the form of a housing that defines a docking space 21. The docking space 21 is delimited by a bottom wall 22 of the housing and the side walls 23 which protrude from the bottom wall 22.

The docking space 21 thus has a shape matching the shape of the removable device 12.

In a variant, the docking space 21 is defined only by the bottom wall 22 and therefore has a space adjacent to said bottom wall 22 without being delimited by the side walls 23. In this case, the docking device 14 defines means of attachment, e.g. in the form of grooves extending parallel to the bottom wall 22 in the upper and lower parts of the device 14.

In the example described, the docking device 14 is built-into the passenger seat in front of the passenger using the communication system 10.

Inside the housing, the docking device 14 comprises a communication chip 31, a communication module 32 and an induction charger 33.

The communication chip 31 has an Extreme High-Frequency chip which can remotely exchange digital data in the form of radio signals with another chip with a similar structure.

“Extreme High Frequency” or “Extremely High Frequency” refers to a radio frequency band ranging from 30 to 300 GHz. Said band is also known in the state of the art under the abbreviation “EHF”.

The communication chip 31 is apt to send digital data using an Ethernet-type communication protocol and advantageously, provides a speed equivalent to one gigabit per second (“Gigabit Ethernet”).

The communication chip 31 is e. g. arranged adjacent to the bottom wall 22 inside the housing of the docking device 14.

The communication module 32 is used to send digital data and/or analog signals received from the exterior to the communication chip 31.

More particularly, in the first case, the communication module 32 has a network card apt to communicate with the aircraft computer network via either a wired link or a wireless link to sent digital data coming from said network to the communication chip 31. Advantageously, the communication module 32 can be further used to send digital data from the communication chip 31 to the computer network.

In the second case, the communication module 32 has a module to convert the analog signals received from the corresponding source into digital data for the communication chip 31.

The induction charger 33 is connected to a power source, e. g. to a power grid of the aircraft and is apt to generate a magnetic field suitable for supplying power to another component, as described in the following.

Thus, the induction charger 33 is e.g. in the form of an induction solenoid.

Moreover, in the example shown in the figure, the charger 33 is used to supply power to the internal components of the docking device 14, such as the communication chip 31 and the communication module 32.

The charger 33 is e.g. arranged adjacent to the bottom wall 22 in the housing of the docking device 14.

With reference to the enclosed figure, the removable device 12 is in the form of a housing defining a rear wall 42, side walls 43 and a front wall 44.

When the removable device 12 is received in the docking space area 21, the rear wall 42 is opposite the bottom wall 22 of the docking device 14 and the side walls 43 are opposite the corresponding side walls 23 of the docking device 14.

The front wall 44 is therefore, facing the passenger using the system 10.

In the variant where the docking device 14 does not have the side walls 23 protruding from the bottom wall 22, the housing of the removable device 12 further comprises fastening means arranged e. g. on the side walls 43 of said housing. The fastening means are apt to mate with the fastening means of the docking device 14 in order to fasten the removable device 12. Thus e. g. when the fastening means of the docking device 14 are in the form of grooves, the fastening means of the removable device 12 can be in the form of clamps suitable for being engaged in these grooves. Of course, other examples of the fastening means of each of the devices 12, 14 are also possible.

The removable device 12 comprises a display screen 50, a communication chip 51, a processing module 52 and an induction charging receiver 53.

The communication chip 51 is similar to the communication chip 31 of the docking device 31. Thus, as in the previous case, the communication chip 31 has an extreme high-frequency chip apt to exchange digital data in the form of radio signals with a similar chip.

The communication chip 51 is arranged in housing of the removable device 12 so that when the removable device 12 is received in the docking space 21, the communication chips 31, 51 are located opposite each other. For example, the communication chip 51 is adjacent to the rear wall 42.

The display screen 50 is known per se.

In particular, the display screen 50 is received in the front wall 44 of the removable device and defines a display surface extending substantially below the entire front wall 44.

The screen 50 displays images from a video stream, as is known per se.

Moreover, advantageously, the display screen 50 is a touch screen insofar as same incorporates a transparent touch panel apt to generate touch commands following a passenger's touch interactions with the display surface.

The processing module 52 is used to convert digital data received by the communication chip 51 from the communication chip 31 into a video stream and to send said video stream to the display screen 50.

Moreover, when the screen 50 is a touch screen, the processing device 52 is apt to acquire touch commands generated by the screen 50 and to generate a video stream in response to said commands or to then send the commands to the communication chip 31 of the docking device 14 via the communication chip 41 of the removable device 12.

The induction charging receiver 53 is arranged adjacent to the rear wall 42 inside the housing of the removable device 12 so as to be opposite the induction charging module 33 of the docking device 14 when the removable device 12 is received in the docking space 21.

Thus, in this position, the induction charging receiver 53 is apt to generate an electrical current from the magnetic field generated by the charger 33.

With the current generated, the receiver 53 is apt to supply power to all the internal components of the removable device 12, in particular the display screen 50, the chip 51, the processing module 52 and the receiver 53.

According to an example of embodiment, the removable device 12 further comprises a battery apt to supply power to all the internal components of the removable device and which can be charged by the receiver 53.

The holding devices 16 are apt to hold the rear wall 42 of the removable device 12 away from the bottom wall 22 of the docking device 14 by a predetermined distance when the removable device 12 is received in the docking device 14.

Said predetermined distance is chosen e.g. in order to provide an optimal transmission speed for digital data between chips 31, 51 and/or to provide an optimal charging of the receiver 53 by the magnetic field induced by the charger 33.

Moreover, the holding means 16 are configured to dampen relative movements of the docking station 14 and of the removable device 12 in order to maintain the predetermined distance substantially constant or within a predetermined range of values.

According to an example of embodiment, for this purpose, the holding means 16 comprises one or a plurality of conductive spacers arranged between the bottom wall 22 and the rear wall 42.

In addition, the holding devices 16 further comprise a locking device suitable for locking and unlocking the removable device 12 in the inserted position thereof into the docking space 21.

Optionally, the communication system 10 according to the present invention, further comprises tilting means (not shown) apt to hold the docking device 14 in the corresponding seat according to an adjustable tilt angle.

In this way, the passenger can choose the tilt angle of the display screen 50.

In operation, in order to activate the display screen 50, it is enough to simply insert the removable device 12 into the docking device 14 and possibly lock same in the docking space 21.

The receiver 53 is therefore powered by the charger 33 and supplies power to all components of the removable device 12. The chips 31 and 51 communicate with each other by sending digital data. At least some of said data then corresponds to a digital stream which is displayed on the display screen 50.

When it is necessary to replace the removable device 12 e.g. following a failure of the display 50, it is sufficient to remove same, where appropriate, by unlocking the locking device. Another removable device can then be inserted in place of the removed device.

It is then easy to understand that the present invention has a number of advantages.

First of all, the present invention makes it possible to remove any connectors from the rear or the side wall of a display device which has a display screen built-in. Thus, such a display device becomes easily removable.

In particular, this makes the maintenance of such a device easy to perform.

Moreover, insofar as the removable device is connected without any mechanical contact, any mechanical wear of the connectors over time is prevented and makes the assembly particularly resistant to vibrations. Said assembly can be completed, if appropriate, with a spacer in order to further dampen the vibrations and thus make the connection stable. In this way, the system becomes particularly suitable for operation in the aviation environment.

Finally, the absence of specific connectors makes the assembly more compact.

It is clear that the display screen 50 of the removable device 12 is apt to display images from the digital data sent by the communication chip 31 of the docking device 14 to the communication chip 51 of the removable device 12, only when the removable device 12 is received by docking device 14. Indeed, the extreme high-frequency communication chips 31/51 are apt to exchange digital data with each other only when same are opposite and substantially close to each other. Indeed, the extreme high-frequency of the radio signals emitted and received by the communication chips 31/51, induces a strong attenuation of said signals with distance.

1. A communication system comprising:
a removable device comprising a display screen; and
a docking device apt to receive the removable device;
wherein
the removable device and the docking device each comprise an extreme high frequency communication chip, the communication chips being arranged opposite each other without any contact when the removable device is received in the docking device and in this position, are apt to exchange digital data in the form of radio signals between them;
the display screen is apt to display images from the digital data sent by the communication chip of the docking device to the communication chip of the removable device.

2. The system according to claim 1, wherein the docking device further comprises a communication module connected to a computer network via either a wired link or a wireless link, the communication chip of the docking device being apt to exchange digital data with said computer network via the communication module.

3. The system according to claim 1, wherein the communication chips are apt to exchange digital data between them through an Ethernet-type protocol.

4. The system according to claim 1, wherein:
the docking device further comprises an induction charger connected to a power supply source;
the removable device further comprises an induction charging receiver arranged opposite the induction charger when the removable device is received in the docking device and apt to generate an electrical current in this position by interaction with the induction charger, for supplying power to the components of the removable device.

5. The system according to claim 4, wherein the removable device has a housing defining a rear wall, side walls and a front wall;
the front wall receiving the display screen;
the rear wall and the side walls defining a smooth surface without any connecting elements.

6. The system according to claim 1, wherein the docking device comprises a bottom wall and the removable device comprises a rear wall configured to be opposite the bottom wall when the removable device is received in the docking device;
the system further comprising holding means apt to hold the rear wall away from the bottom wall by a predetermined distance when the removable device is received in the docking device.

7. The system according to claim 6, wherein the holding means comprises a conductive spacer arranged between the bottom wall and the rear wall.

8. The system according to claim 1, configured to be arranged in an environment which is subject to vibrations.

9. The system according to claim 1, having an entertainment terminal for passengers of a mobile means of transport.

10. The system according to claim 9, wherein the docking device is built-into a seat in front of the passenger seat for which the entertainment terminal is configured.

11. The system according to claim 10, further comprising tilting means apt to hold the docking device in the corresponding seat according to an adjustable tilt angle.
